(19) United States
(12) Patent Application Publication
(10) Pub. No.: US 2025/0051161 A1
(43) Pub. Date: Feb. 13, 2025

(54) PROCESS FOR HYDROGEN PRODUCTION WITH LOW CARBON DIOXIDE EMISSION

(71) Applicant: Linde GmbH, Pullach (DE)

(72) Inventors: Werner LEITMAYR, Pullach (DE); Martin LANG, Pullach (DE)

(21) Appl. No.: 18/720,328

(22) PCT Filed: Nov. 16, 2022
(86) PCT No.: PCT/EP2022/025515

§ 371 Date: Jun. 14, 2024

(30) Foreign Application Priority Data
Dec. 21, 2021 (EP) 21020650.4

(51) Int. Cl. C01B 3/56

(52) U.S. Cl. CPC C01B 3/56; C01B 2203/0205; C01B 2203/0283; C01B 2203/043; C01B 2203/046; C01B 2203/0475; C01B 2203/147; C01B 2203/86

(57) ABSTRACT

A process for producing a hydrogen product where a carbon-containing input, by reforming and water gas shift, is converted into a synthesis gas largely consisting of hydrogen and carbon dioxide, from which a hydrogen fraction and a carbon dioxide fraction are separated, wherein the hydrogen fraction has the composition required for the hydrogen product and the carbon dioxide fraction has a purity which allows delivery thereof as a product or disposal thereof through sequestration. The characterizing feature here is that the synthesis gas consisting largely of hydrogen and carbon dioxide, by means of a first pressure swing adsorber, is fractionated into a carbon dioxide-depleted first PSA high-pressure fraction and a carbon dioxide-enriched first PSA low-pressure fraction, from which, after compression, the carbon dioxide fraction is obtained by cryogenic gas fractionation.

The invention relates to a process for producing a hydrogen product where a carbon-containing input, by reforming and water gas shift, is converted into a synthesis gas largely consisting of hydrogen and carbon dioxide, from which a hydrogen fraction and a carbon dioxide fraction are separated, wherein the hydrogen fraction has the composition required for the hydrogen product, and the carbon dioxide fraction has a purity which allows delivery thereof as a product or disposal thereof through sequestration.

In the present text, a hydrogen product means a gas that has a composition required for delivery as a product, with a hydrogen content of more than 98 vol. %. Examples of hydrogen products are pure hydrogen with a hydrogen content of more than 99.9 vol. % and fuel gas that consists of at least 98 vol. % hydrogen.

According to the prior art, hydrogen is obtained on an industrial scale mainly from hydrocarbon-containing inputs such as natural gas in particular. The inputs are converted by partial oxidation (POX), steam reforming (SMR) or autothermal reforming (ATR) or combinations of these processes into a raw synthesis gas that contains nitrogen, carbon monoxide, methane, carbon dioxide and water in addition to hydrogen. To increase the hydrogen yield, the raw synthesis gas is subjected to a water gas shift to react the carbon monoxide it contains with water to form hydrogen and carbon dioxide and to obtain a largely carbon monoxide-free synthesis gas from which the hydrogen product is separated.

In order to keep the carbon footprint small, the aim is to minimize hydrocarbon-containing fuel gases and to achieve a high level of heat integration, by means of which, for example, the hydrocarbon-containing input and/or the fuel gas required to operate a steam reformer is/are preheated to high temperatures in heat exchange with process streams to be cooled. In addition, carbon dioxide, which may be present in the flue gas of a steam reformer and/or the synthesis gas produced, is either sequestered or fed for material use. In both cases, it is necessary to obtain the carbon dioxide with a specified purity. For this purpose, the carbon dioxide-containing gas mixture is usually subjected to amine scrubbing, which can separate more than 99% of the carbon dioxide present out of a synthesis gas or 95-98% of same out of a flue gas.

Depending on whether the synthesis gas or the resulting flue gas is subjected to amine scrubbing in steam reforming-based hydrogen production, a carbon capture rate, which indicates the ratio of the amount of carbon separated out with the carbon dioxide to the amount of carbon introduced into the process, of between 50 and 65% or more than 90% can be achieved. If the hydrogen is produced with less flue gas formation, as is the case with ATR- or POX-based plants comprising a fired heater, carbon capture rates of over 90% are achieved by amine scrubbing of the synthesis gas.

However, the disadvantages here are the high investment costs incurred for amine scrubbing and the high energy requirement for regenerating the loaded amine scrubbing agent, which is usually covered by steam. When the flue gas is scrubbed, scrubbing agent losses also account for a considerable proportion of the operating costs.

It is therefore the object of the invention to specify a process of the type in question that makes it possible to achieve high carbon capture rates of more than 90% at lower costs than is possible according to the prior art.

The object is achieved in the process according to the invention in that the synthesis gas consisting largely of hydrogen and carbon dioxide, by means of a first pressure swing adsorber (PSA), is fractionated into a carbon dioxide-depleted first PSA high-pressure fraction and a carbon dioxide-enriched, water-containing first PSA low-pressure fraction, from which the carbon dioxide fraction is obtained by cryogenic gas fractionation.

The water gas shift is preferably designed as a combination of high and low temperature shift or medium and low temperature shift.

Expediently, a cooling device is arranged between the water gas shift and the first pressure swing adsorber, in which cooling device the synthesis gas is cooled to below the water dew point in order to separate off most of the water it contains and to obtain a largely water-free synthesis gas.

Depending on the requirements placed on the purity and delivery conditions (pressure, state of matter) of the carbon dioxide fraction, the cryogenic gas fractionation can be carried out in different ways, which have the following principle in common:

The compressed and dried first PSA low-pressure fraction is cooled and partially condensed, wherein most of the impurities present—in particular hydrogen—are separated in a high-pressure separator into a fraction known as HP flash gas. The carbon dioxide-rich liquid fraction obtained in the high-pressure separator can be subjected to further purification steps depending on the purity requirements applicable to the carbon dioxide fraction.

If the carbon dioxide fraction is to be disposed of by sequestration, a second expansion step with subsequent gas/liquid separation is usually sufficient to obtain a second carbon dioxide-rich liquid fraction, which meets the purity requirements, from the first. The resulting gas fraction, known as MP flash gas, is preferably fed back via an intermediate feed to the compressor used to compress the first PSA low-pressure fraction.

The liquid fraction that is obtained during the second gas/liquid separation or possibly another separation step carried out with the aid of a stripping column, for example, and has the required composition of the carbon dioxide fraction, can be evaporated and delivered in gaseous form after compression. Alternatively, it can be pressurized by pumping before evaporation. This usually requires a carbon dioxide recycle, which is delivered, for example, as an intermediate feed to the compressor used to compress the first PSA low-pressure fraction. It is also possible to deliver the carbon dioxide fraction in liquid form, wherein the cooling requirement of the cryogenic gas fractionation is expediently covered by an external ammonia or propylene or mixed refrigeration circuit.

Pressure swing adsorbers (PSAs) are generally used to separate gaseous substance mixtures. They utilize the different adsorption forces of the various molecules or atoms of a gas mixture against an adsorbent. A pressure swing adsorber comprises multiple adsorber vessels filled with the adsorbent, which are periodically switched between adsorption operation at high pressure and desorption operation, which takes place at a much lower pressure.

A typical PSA fractionates an inlet stream fed at adsorption pressure into a PSA high-pressure fraction, the pressure of which corresponds approximately to the adsorption pressure, and a PSA low-pressure fraction produced at desorption pressure.

A widespread PSA application is the recovery of the more poorly or most poorly adsorbable component(s) of the inlet stream in enriched or pure form as a PSA high-pressure fraction. In the case of the synthesis gas, this is hydrogen, which is adsorbed much more poorly than carbon dioxide. However, it is also possible to recover the more easily or most easily adsorbable component, i.e. carbon dioxide, in enriched or pure form as a PSA low-pressure fraction.

A preferred embodiment of the process according to the invention provides for the first pressure swing adsorber to be designed and operated in such a way that at least 95%, preferably more than 99%, of the carbon dioxide present in the synthesis gas passes into the first PSA low-pressure fraction, and at least 92%, preferably more than 95%, of the hydrogen present in the synthesis gas simultaneously passes into the first PSA high-pressure fraction.

In addition to hydrogen and carbon dioxide, the synthesis gas can also contain methane, carbon monoxide or nitrogen. To reduce the energy required to compress the PSA low-pressure fraction, it is further proposed to design and operate the first pressure swing adsorber such that at least 50%, preferably more than 65%, of the methane, at least 70%, preferably more than 80%, of the carbon monoxide and at least 80%, preferably more than 85%, of the nitrogen from the synthesis gas passes into the first PSA high-pressure fraction.

Under the specified conditions, the first PSA high-pressure fraction usually does not meet the purity requirements placed on a hydrogen product. It is therefore proposed to feed the first PSA high-pressure fraction to a second pressure swing adsorber, which is designed and operated such that a second PSA high-pressure fraction is obtained, with a purity that allows it to be delivered as a hydrogen product. Expediently, the first PSA high-pressure fraction is used upstream of the second pressure swing adsorber as regeneration gas in a temperature swing adsorber, which is used to separate out water residues and possibly methanol from the compressed first PSA low-pressure fraction.

In the specified mode of operation of the first pressure swing adsorber, the HP flash gas obtained in the cryogenic gas fractionation is preferably fed back into the synthesis gas to be separated, upstream of the first pressure swing adsorber, in order to increase the hydrogen yield. Expediently, the first PSA low-pressure fraction is compressed to such an extent that the HP flash gas from the cryogenic gas fractionation can be fed back without further compression.

A development of the process according to the invention provides for the second PSA low-pressure fraction enriched with the residual components of the HP flash gas in the second pressure swing adsorber to be fed back and used for bottom firing in a heating device used in the reforming of the hydrocarbon-containing input. Before being used for bottom firing, the second PSA low-pressure fraction is expediently warmed against synthesis gas to be cooled.

If the quantity of the second PSA low-pressure fraction is not sufficient to operate the heating device, it can be supplemented with a part of the first PSA high-pressure fraction. Preferably, this part of the PSA high-pressure fraction is separated for this purpose via a membrane into a hydrogen-rich permeate, which is combined with the second PSA low-pressure fraction, and a carbon monoxide- and methane-rich retentate, which is fed to the reforming process together with the carbon-containing input.

If the quantity of the second PSA low-pressure fraction is too large to be completely used for bottom firing in the heating device, the excess can be fed back upstream of the second pressure swing adsorber to increase the hydrogen yield. It is also possible to feed the excess of the second PSA low-pressure fraction together with the carbon-containing input to the reforming process.

This type of synthesis gas treatment can be used with particular preference when the carbon-containing input, which is natural gas for example, is reformed with the aid of a pre-reformer and an autothermal reformer (ATR), wherein the pre-reformer is arranged upstream of the ATR in order to be able to operate it with a lower steam/carbon ratio.

Another preferred embodiment of the process according to the invention provides for the first pressure swing adsorber to be operated such that the first PSA high-pressure fraction is obtained with a composition that allows it to be delivered as a hydrogen product. In order to maximize the partial pressure of the carbon dioxide in the PSA low-pressure fraction, the first pressure swing adsorber is also expediently designed and operated such that at least 90% of the hydrogen present in the synthesis gas passes into the PSA high-pressure fraction.

In this procedure, the HP flash gas obtained during cryogenic gas fractionation is fed to a second pressure swing adsorber, which is operated in such a way that at least 95%, preferably more than 99%, of the carbon dioxide present in the HP flash gas passes into the second PSA low-pressure fraction, and at least 92%, preferably more than 95%, of the hydrogen present in the HP flash gas simultaneously passes into the second PSA high-pressure fraction.

In addition to hydrogen and carbon dioxide, the HP flash gas can also contain methane, carbon monoxide or nitrogen. Expediently, the second pressure swing adsorber is designed and operated such that at least 50%, preferably more than 65%, of the methane, at least 70%, preferably more than 80%, of the carbon monoxide and at least 80%, preferably more than 85%, of the nitrogen passes into the second PSA high-pressure fraction.

The carbon dioxide-rich second PSA low-pressure fraction is preferably combined with the first PSA low-pressure fraction to be compressed and fed with this to the cryogenic gas fractionation. Preferably, the hydrogen-rich second PSA high-pressure fraction is separated via a membrane into a hydrogen-rich permeate, which is fed back and used for bottom firing in a heating device used in the reforming of the hydrocarbon-containing input, and a carbon monoxide- and methane-rich retentate, which is fed to the reforming together with the carbon-containing input. Before being used for bottom firing, the hydrogen-rich permeate is expediently warmed against synthesis gas to be cooled, while the second PSA high-pressure fraction is expediently used upstream of the membrane as regeneration gas in a temperature swing adsorber, which serves to separate out water residues and possibly methanol from the compressed first PSA low-pressure fraction.

This type of synthesis gas treatment can be used with particular preference when the carbon-containing input, which is natural gas for example, is reformed using a combination of a burner-fired steam reformer (SMR), a pre-reformer upstream of the SMR, and a gas-heated reformer (GHR), wherein the GHR, which is located either in the side stream parallel to the SMR or upstream of the SMR, is heated via the hot raw synthesis gas emerging from the SMR. Thanks to the GHR, which assumes at least 10-30% of the reforming reaction, the firing power required to operate the pre-reformer and SMR can be minimized.

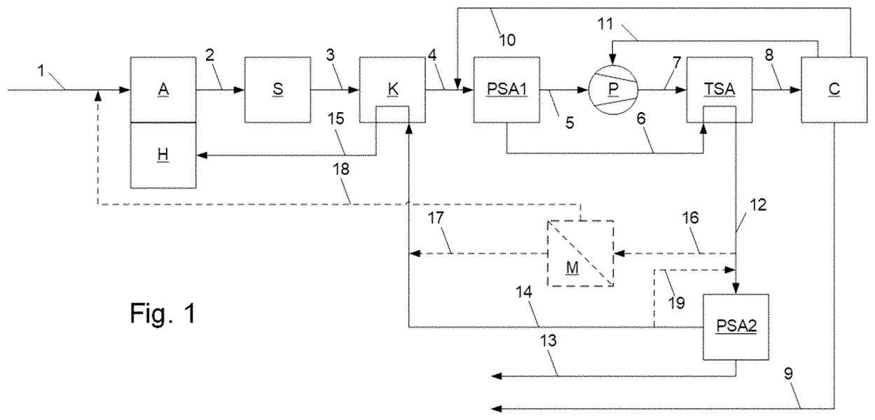

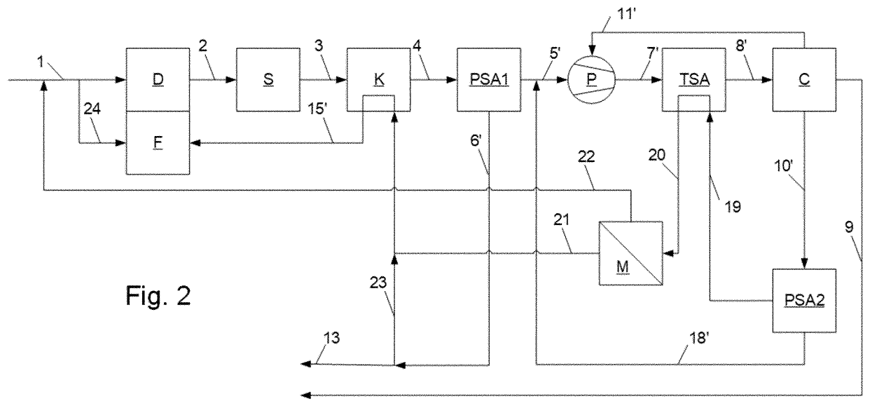

The invention shall be explained in more detail below using two exemplary embodiments schematically illustrated in FIGS. 1 and 2.

FIG. 1 shows hydrogen production using an autothermal reformer according to a preferred embodiment of the process according to the invention.

FIG. 2 shows hydrogen production using a burner-fired steam reformer according to another preferred embodiment of the process according to the invention.

The same components are labeled with the same symbols in both figures.

In the exemplary embodiment of FIG. 1, a hydrocarbon-containing input 1 such as natural gas is fed to the reforming device A, which is designed with a pre-reformer and an autothermal reformer (ATR), in order to be converted into a raw synthesis gas 2 containing hydrogen, nitrogen, carbon monoxide, carbon dioxide, water and methane. The pre-reformer is arranged upstream of the ATR and allows the ATR to be operated with a lower steam/carbon ratio. In the subsequent water gas shift S, which is preferably designed as a combination of high and low temperature shift or medium and low temperature shift, carbon monoxide is reacted with water to give hydrogen and carbon dioxide, so that a largely carbon monoxide-free synthesis gas 3 is obtained, which is fed to the first pressure swing adsorber PSA1 via line 4 after the condensation of water in the cooling device K. The first pressure swing adsorber PSA1 is designed and operated such that at least 95%, preferably at least 99%, of the carbon dioxide present in the cooled and dehydrated synthesis gas 4 passes into the first PSA low-pressure fraction 5, which has a slight overpressure. At the same time, at least 92%, but preferably more than 95%, of the hydrogen present in the synthesis gas 4 together with at least 50%, preferably more than 65%, of the methane, at least 70%, preferably more than 80%, of the carbon monoxide and at least 80%, preferably more than 85%, of the nitrogen remain in the first PSA high-pressure fraction 6.

After a pressure increase by means of the multi-stage compressor P, the first PSA low-pressure fraction 5 is fed via line 7 into the temperature swing adsorber TSA for the separation of water and any methanol present, from where it is fed via line 8 to the cryogenic fractionation C in order to be fractionated in a condensation process into a carbon dioxide fraction 9, a hydrogen-rich, high-pressure flash gas 10 containing nitrogen, carbon dioxide, carbon monoxide and methane, and a carbon dioxide-rich, medium-pressure flash gas 11 containing hydrogen, nitrogen, carbon monoxide and methane. While the carbon dioxide fraction can be delivered as a product or disposed of by sequestration due to its composition, the two flash gases 10, 11 are fed back upstream of the first pressure swing adsorber or as an intermediate feed into the compressor P, in order to increase the yield.

The first PSA high-pressure fraction 6 is used as regeneration gas in the temperature swing adsorber TSA before it is fed via line 12 to a second pressure swing adsorber PSA2, which is designed and operated such that a second PSA high-pressure fraction 13 is obtained with a composition that allows it to be delivered as a hydrogen product. The second PSA low-pressure fraction 14 is warmed in the cooling device K against the largely carbon monoxide-free synthesis gas 3 and fed via line 15 to the heating device H, which is used to generate process steam and preheat the input material, for bottom firing.

If the second PSA low-pressure fraction 14 is not sufficient to operate the heating device H, a part 16 of the hydrogen-rich gas stream 12 containing nitrogen, carbon monoxide and methane and low in carbon dioxide can be added to it. One variant provides for the material stream 16 to be conducted via a membrane M to obtain a hydrogen-rich permeate 17, which is combined with the second PSA low-pressure fraction 14, and a carbon monoxide- and methane-rich retentate 18, which is added to the input 1 for the reforming device A after compression (not shown) to increase the carbon capture rate.

If the quantity of the second PSA low-pressure fraction 14 is too large to be completely used for bottom firing in the heating device H, a part 19 can be compressed (not shown) and fed back upstream of the second pressure swing adsorber PSA2 in order to increase the hydrogen yield. It is also possible for the excess of the second PSA low-pressure fraction 14 to be fed back upstream of the reforming device A.

In the exemplary embodiment shown in FIG. 2, the reforming device D comprises a burner-fired steam reformer (SMR) with an upstream pre-reformer and a gas-heated reformer (GHR), which is located either in the side stream parallel to the SMR or upstream of the SMR. With the GHR heated by the hot raw synthesis gas exiting the SMR, which serves to minimize the firing power required for the operation of the pre-reformer and SMR, it assumes at least 10-30% of the reforming reaction taking place in the reforming device D.

In contrast to the exemplary embodiment of FIG. 1, the first pressure swing adsorber PSA1 is designed and operated such that the first PSA high-pressure fraction 6′ is obtained with a quality that allows it to be delivered as a hydrogen product. At the same time, at least 90% of the hydrogen present in the dehydrated synthesis gas 4 is transferred to the first PSA high-pressure fraction 6′ in order to achieve a high partial pressure of the carbon dioxide in the PSA low-pressure fraction 5′.

After increasing the pressure in the multi-stage compressor P, the compressed PSA low-pressure fraction 7′ is fed into the temperature swing adsorber TSA, from which a dried material stream 8′, from which methanol has been removed if necessary, is transferred to the cryogenic fractionation C, in order to be fractionated in a condensation process into a carbon dioxide fraction 9, a hydrogen-rich, high-pressure flash gas 10′ containing nitrogen, carbon dioxide, carbon monoxide and methane, and a carbon dioxide-rich medium-pressure flash gas 11′ containing hydrogen, nitrogen, carbon monoxide and methane. While the carbon dioxide fraction 9 can be delivered as a product or disposed of by sequestration due to its composition, the medium-pressure flash gas 11′ is fed back into the compressor P as an intermediate feed, and the high-pressure flash gas 10′ is introduced into the second pressure swing adsorber PSA2.

The task of the second pressure swing adsorber PSA2 is to separate as much of the carbon dioxide present in the high-pressure flash gas 10′ as possible in order to transfer it to the carbon dioxide fraction 9 via the multi-stage compressor P and the cryogenic fractionation C. The second pressure swing adsorber PSA2 is designed and operated such that at least 95%, preferably at least 99%, of the carbon dioxide present in the high-pressure flash gas 10′ passes into the second PSA low-pressure fraction 18′, which has a slight overpressure and is fed back to the suction side of the multi-stage compressor P. At the same time, at least 92%, but preferably more than 95%, of the hydrogen present in the high-pressure flash gas 10′ together with at least 50%, preferably more than 65%, of the methane, at least 70%, preferably more than 80%, of the carbon monoxide and at least 80%, preferably more than 85%, of the nitrogen remain in the second PSA high-pressure fraction 19.

The hydrogen-rich second PSA high-pressure fraction 19 is preferably used as regeneration gas in the temperature swing adsorber TSA and then introduced via line 20 into the membrane unit M for further material separation, where a hydrogen-rich permeate 21 and a carbon monoxide- and methane-rich, hydrogen-containing retentate 22 are formed. The retentate 22 is fed back into the reforming device D and delivered to the pre-reformer due to its carbon monoxide content, while the permeate 21 is warmed in the cooling device K after mixing with a product-quality material stream 23 and burned as fuel stream 15′ in the combustion chamber F of the steam reformer D. The material stream 23 is a part of the first PSA high-pressure fraction 6′, the remainder of which forms the hydrogen product 13. The size of the material stream 23 is selected so that no or only very little hydrocarbon-containing fuel gas 24 has to be added to cover the heating requirements of the steam reformer.

1. A process for producing a hydrogen product where a carbon-containing input, by reforming and water gas shift, is converted into a synthesis gas largely consisting of hydrogen and carbon dioxide, from which a hydrogen fraction and a carbon dioxide fraction are separated, wherein the hydrogen fraction has the composition required for the hydrogen product, and the carbon dioxide fraction has a purity which allows delivery thereof as a product or disposal thereof through sequestration, wherein the synthesis gas consisting largely of hydrogen and carbon dioxide, by means of a first pressure swing adsorber, is fractionated into a carbon dioxide-depleted first PSA high-pressure fraction and a carbon dioxide-enriched first PSA low-pressure fraction, from which, after compression, the carbon dioxide fraction is obtained by cryogenic gas fractionation.

2. The process according to claim 1, wherein the cryogenic gas fractionation comprises two separation steps by which a first flash gas and a second flash gas comprising hydrogen and carbon dioxide are produced, wherein the first flash gas (HP flash gas) has a higher pressure than the second flash gas (MP flash gas).

3. The process according to claim 1, wherein the carbon dioxide fraction is withdrawn in liquid form from the cryogenic gas fractionation.

4. The process according to claim 1, wherein the cold required for the cryogenic gas fractionation is provided via an ammonia refrigeration circuit or a propylene refrigeration circuit or a mixed refrigeration circuit.

5. The process according to claim 1, wherein the first pressure swing adsorber is designed and operated such that more than 95%, preferably more than 99%, of the carbon dioxide present in the synthesis gas passes into the first PSA low-pressure fraction.

6. The process according to claim 5, wherein the synthesis gas contains methane and/or carbon dioxide and/or nitrogen, and the first pressure swing adsorber is designed and operated such that at least 50%, preferably more than 65%, of the methane, at least 70%, preferably more than 80%, of the carbon monoxide and at least 80%, preferably more than 85%, of the nitrogen passes into the first PSA high-pressure fraction.

7. The process according to the claim 5, wherein the first PSA high-pressure fraction is fed to a second pressure swing adsorber in order to be fractionated into a carbon dioxide-depleted second PSA high-pressure fraction, which has the required composition for the hydrogen product, and a second PSA low-pressure fraction.

8. The process according to claim 7, in that at least a part of the second PSA low-pressure fraction is used as heating gas in the reforming.

9. The process according to claim 5, wherein the first PSA low-pressure fraction is compressed to such an extent that the HP flash gas from the cryogenic gas fractionation can be fed back upstream of the first pressure swing adsorber without further compression.

10. The process according to claim 1, wherein the first pressure swing adsorber is designed and operated such that the first PSA high-pressure fraction has the composition required for the hydrogen product, wherein at least 90% of the hydrogen present in the synthesis gas passes into the PSA high-pressure fraction.

11. The process according to claim 10, wherein the hydrogen-rich, carbon dioxide-containing HP flash gas obtained in the cryogenic gas fractionation is fed to a second pressure swing adsorber in order to be fractionated into a carbon dioxide-depleted second PSA high-pressure fraction and a carbon dioxide-enriched second PSA low-pressure fraction, wherein the second pressure swing adsorber is designed and operated such that at least 95%, preferably at least 99%, of the carbon dioxide present in the HP flash gas passes into the second PSA low-pressure fraction, and at the same time at least 92%, but preferably more than 95%, of the hydrogen present in the high-pressure flash gas remains in the second PSA high-pressure fraction.

12. The process according to claim 11, wherein the HP flash gas contains methane and/or carbon dioxide and/or nitrogen, and the second pressure swing adsorber is designed and operated such that at least 50%, preferably more than 65%, of the methane, at least 70%, preferably more than 80%, of the carbon monoxide and at least 80%, preferably more than 85%, of the nitrogen passes into the second PSA high-pressure fraction.

13. The process according to claim 11, wherein the second PSA low-pressure fraction is fed back upstream of the compression P.

14. The process according to claim 13, wherein the second PSA low-pressure fraction is fractionated via a membrane into a hydrogen-rich permeate and a carbon monoxide- and methane-rich retentate, of which the permeate is used as heating gas in the reforming and the retentate is fed back upstream of the reforming device.

15. The process according to claim 13, wherein at least a part of the first PSA high-pressure fraction is used as heating gas in the reforming.
